(19) United States
(12) Patent Application Publication
(10) Pub. No.: US 2022/0052427 A1
(43) Pub. Date: Feb. 17, 2022

(54) ENCAPSULATED BATTERY PACK

(71) Applicant: Apple Inc., Cupertino, CA (US)

(72) Inventors: Russell A. McLellan, San Jose, CA (US); Steven Kaye, Oakland, CA (US)

(21) Appl. No.: 17/400,997

(22) Filed: Aug. 12, 2021

Related U.S. Application Data
(60) Provisional application No. 63/065,924, filed on Aug. 14, 2020.

(51) Int. Cl. H01M 50/533; H01M 50/209; H01M 50/543; H01M 50/54; H01M 50/645; H01M 50/183

(52) U.S. Cl. CPC H01M 50/533; H01M 50/209; H01M 50/183; H01M 50/54; H01M 50/645; H01M 50/543

(57) ABSTRACT

The disclosed technology relates to a battery that utilizes a singular encapsulant layer to seal a plurality of sets of electrodes within individual compartments of an enclosure. The battery includes a plurality of sets of electrodes, an enclosure having a plurality of compartments, wherein each compartment is configured to receive a corresponding set of electrodes, and a singular encapsulant layer disposed over the plurality of compartments. The encapsulant layer seals each set of electrodes within its respective compartment, seals the electrolyte disposed within each compartment, and fully encapsulates an electrical connection between the sets of electrodes.

### PRIORITY

This patent application claims the benefit under 35 U.S.C. § 119(e) of U.S. Patent Application No. 63/065,924 entitled “Encapsulated Battery Pack” and filed on Aug. 14, 2020, which is incorporated herein by reference in its entirety.

### TECHNICAL FIELD

The disclosure relates generally to a battery pack, and more particularly, to an encapsulated battery pack.

### BACKGROUND

Battery packs comprise a plurality of battery cells and are used to provide power to a wide variety of devices. A battery cell may utilize a type of battery chemistry, such as lithium-ion or lead acid, to provide power to devices. It is common for battery chemistry to require different materials for substrates and/or tabs of a cathode and anode. For example, for a lithium-ion battery cell, aluminum may be used as the tab for the cathode and copper may be used as the tab of the anode. Where a battery chemistry requires different materials for the tabs, an electrolyte coming in contact with a connected cathode or anode tab may cause a parasitic reaction where the cathode tab material is at the anode potential, or vice versa.

Certain battery cells may be made of an anode layer and a cathode layer, with a separator disposed there-between. The layers may be stacked or wound in a corresponding compartment of an enclosure. A first conductive tab may be coupled to the cathode layer and a second conductive tab may be coupled to the anode layer. The first and second conductive tabs may be connected to adjacent cells or to terminals for the battery. The battery may include a battery management circuit module that is configured to manage discharging, recharging, and cell balancing.

### SUMMARY

The disclosed embodiments provide for a battery that utilizes a singular encapsulant layer to seal a plurality of sets of electrodes within individual compartments of an enclosure. The battery includes a plurality of sets of electrodes, an enclosure having a plurality of compartments, wherein each compartment is configured to receive a corresponding set of electrodes, and a singular encapsulant layer disposed over the plurality of compartments. The encapsulant layer seals each set of electrodes within their respective compartment. The encapsulant layer fully encapsulates an electrical connection of an anode tab and a cathode tab for each set of electrodes.

In some embodiments, a mold for forming a singular encapsulant layer to seal a plurality of sets of electrodes within individual compartments of an enclosure is disclosed. The mold includes a base defining a fill cavity, a slot surrounding the fill cavity to receive a tab extending from a battery enclosure to align the battery enclosure with respect to the fill cavity, a fill port in fluid communication with the fill cavity to receive a liquid encapsulant, a plurality of protrusions extending through the fill cavity to create a plurality of ports within a cured singular encapsulant layer formed within the fill cavity.

In some embodiments, a method for forming a singular encapsulant layer to seal a plurality of sets of electrodes within individual compartments of an enclosure is disclosed. The method includes inserting a first set of electrodes within a first compartment formed within an enclosure; inserting a second set of electrodes within a second compartment formed within the enclosure; connecting an anode tab of the first set of electrodes to a cathode tab of the second set of electrodes; connecting a cathode tab of the first set of electrodes to a first terminal; connecting an anode tab of the second set of electrodes to a second terminal; and disposing a mold over an opening of the enclosure. The mold forms a singular cavity with the first and second compartments. The method further includes pouring a liquid encapsulant in a fill port formed within the mold, the fill port in fluid communication with the cavity; and encapsulating electrical connections of the anode and cathode tabs of the first and second set of electrodes with the encapsulant to form a singular encapsulant layer. The encapsulant layer seals both the first and second set of electrodes within the first and second compartments, respectively.

### BRIEF DESCRIPTION OF THE DRAWINGS

The embodiments herein may be better understood by referring to the following description in conjunction with the accompanying drawings in which like reference numerals indicate identical or functionally similar elements. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exploded perspective view of a battery, in accordance with various embodiments of the subject technology;

FIG. 2A illustrates a perspective view of a plurality of sets of electrodes of a battery pack inserted within compartments of an enclosure, in accordance with various embodiments of the subject technology;

FIG. 2B illustrates a detailed view of a terminal of a battery pack, in accordance with various embodiments of the subject technology;

FIG. 2C illustrates a partially assembled battery, in accordance with various embodiments of the subject technology;

FIG. 2D illustrates a perspective view of a mold disposed atop of a partially assembled battery, in accordance with various embodiments of the subject technology;

FIG. 2E illustrates an exploded view of a mold, in accordance with various embodiments of the subject technology;

FIG. 2F illustrates a detailed view of a terminal pass-through of a mold, in accordance with various embodiments of the subject technology;

FIG. 2G illustrates a perspective view of a mold and battery assembly, in accordance with various embodiments of the subject technology;

FIG. 2H illustrates a perspective view of a rotated mold and battery assembly, in accordance with various embodiments of the subject technology;

FIG. 2I illustrates a perspective section view of a mold and battery assembly, in accordance with various embodiments of the subject technology;

FIG. 2J illustrates a section view of a mold and battery assembly with a liquid encapsulant, in accordance with various embodiments of the subject technology;

FIG. 2K illustrates a perspective section view of a mold and battery assembly with a singular encapsulant layer, in accordance with various embodiments of the subject technology;

FIG. 2L illustrates a perspective section view of a mold and battery assembly with a singular encapsulant layer, in accordance with various embodiments of the subject technology;

FIG. 2M illustrates a perspective view of a battery assembly with a singular encapsulant layer, in accordance with various embodiments of the subject technology;

FIG. 2N illustrates a perspective view of a battery assembly with a singular encapsulant layer, in accordance with various embodiments of the subject technology;

FIG. 2O illustrates a perspective view of a battery assembly with a singular encapsulant layer, in accordance with various embodiments of the subject technology;

FIG. 2P illustrates a detailed view of a connection between adjacent sets of electrodes, in accordance with various embodiments of the subject technology;

FIG. 2Q illustrates a detailed view of an encapsulated connection between adjacent sets of electrodes, in accordance with various embodiments of the subject technology;

FIG. 3 illustrates an example method for forming a singular encapsulant layer to seal a plurality of sets of electrodes within individual compartments of an enclosure, in accordance with various embodiments of the subject technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

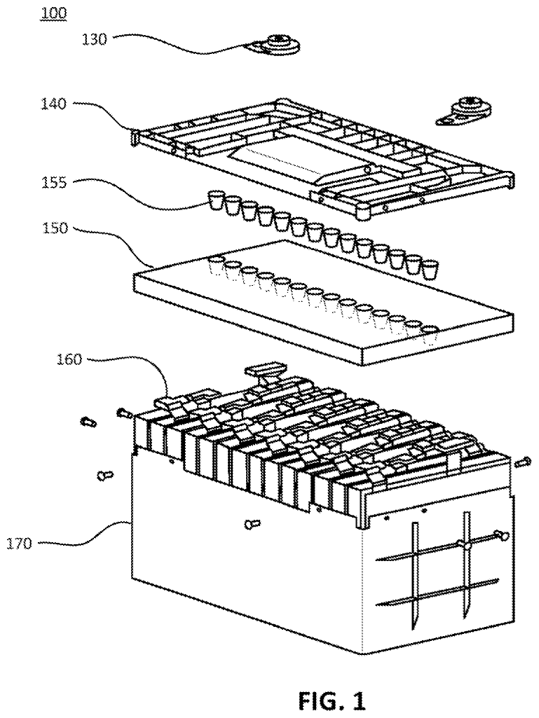

FIG. 1 illustrates an exploded perspective view of a battery 100, in accordance with various embodiments of the subject technology. The battery 100 includes an enclosure 170, a battery pack 160 inserted within the enclosure 170, a terminal connector 130, a lid 140, a singular encapsulant layer 150 disposed over a plurality of sets of electrodes, and a plurality of port plugs 155.

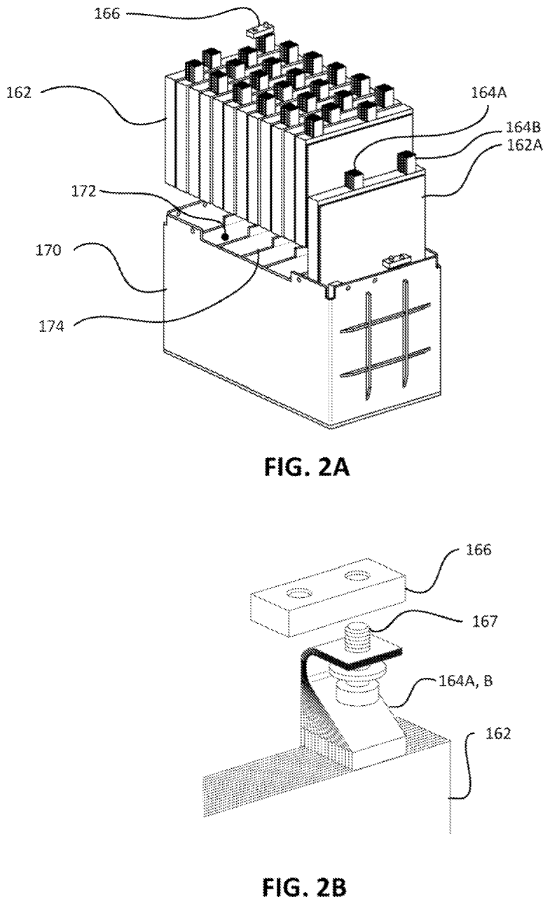

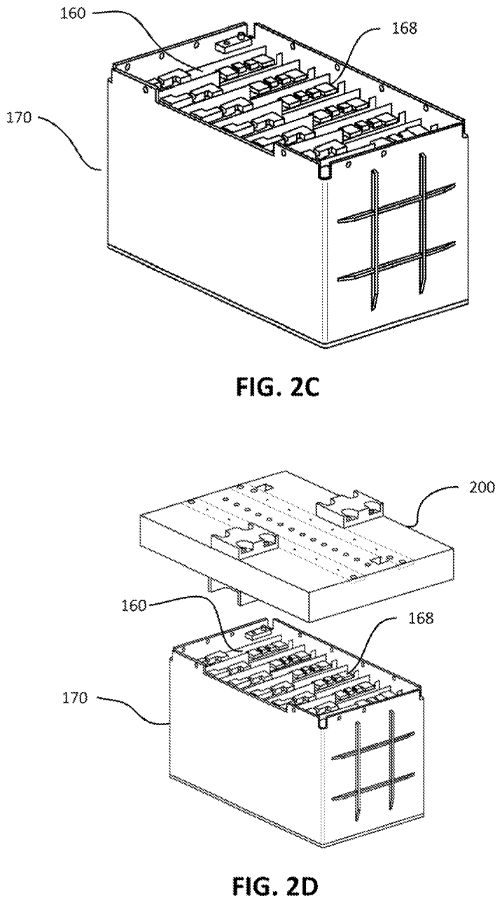

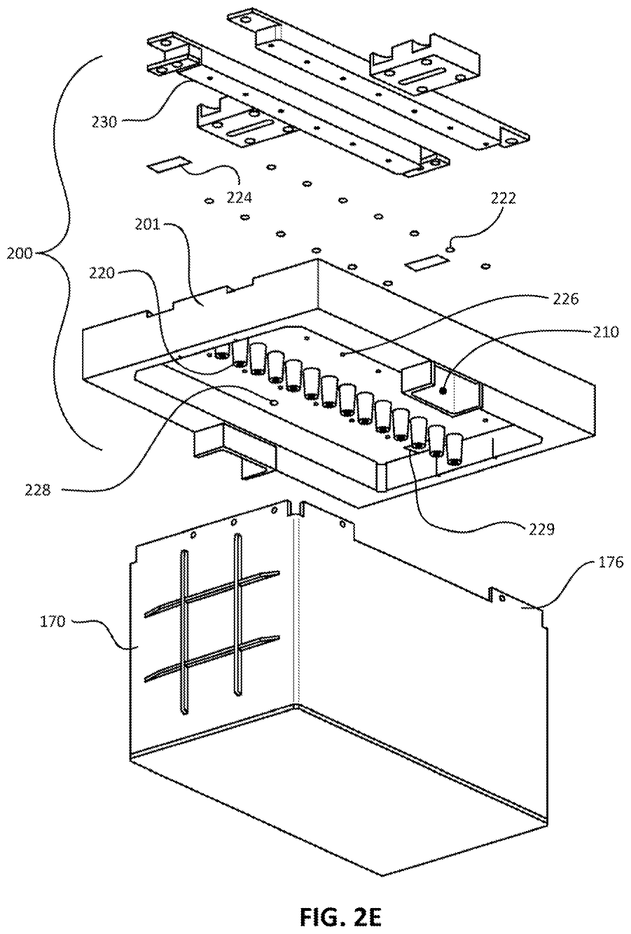

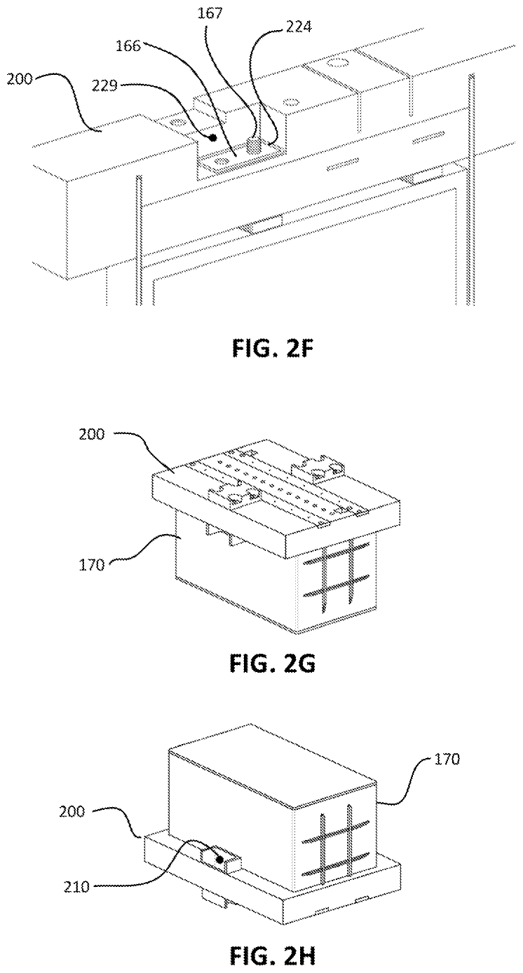

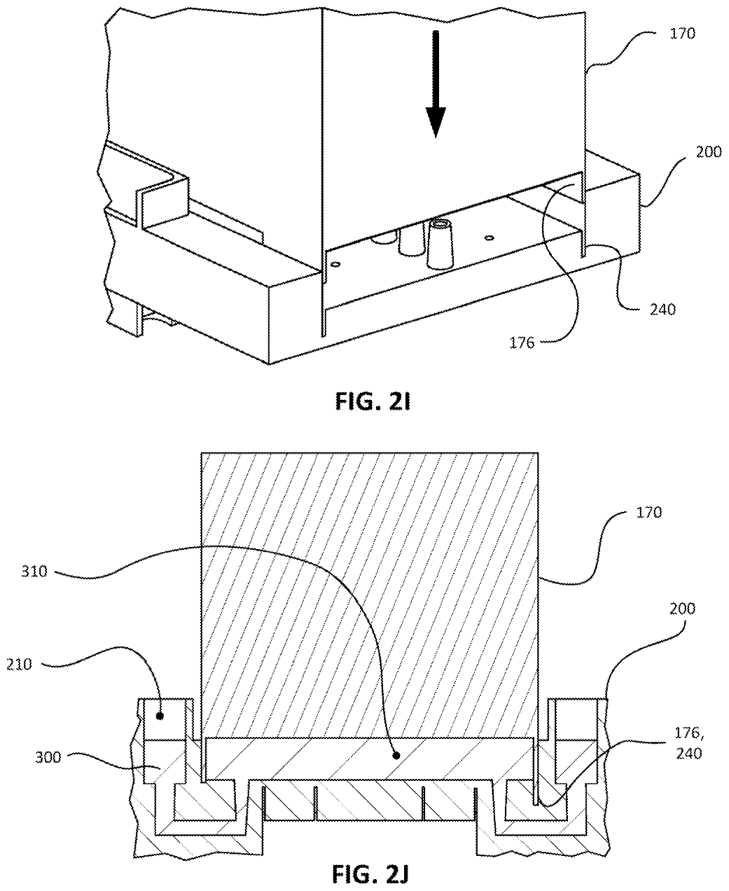

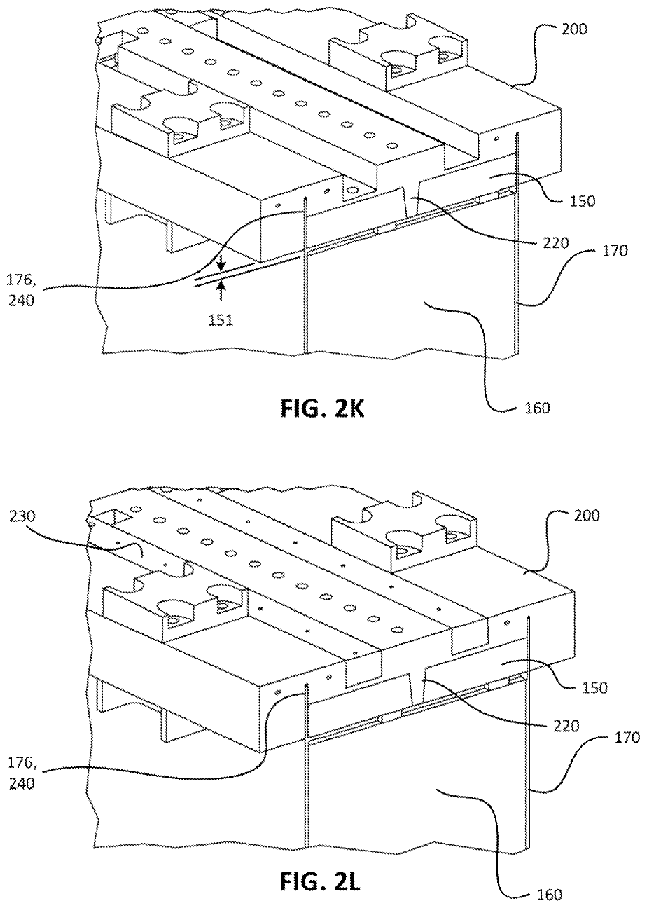

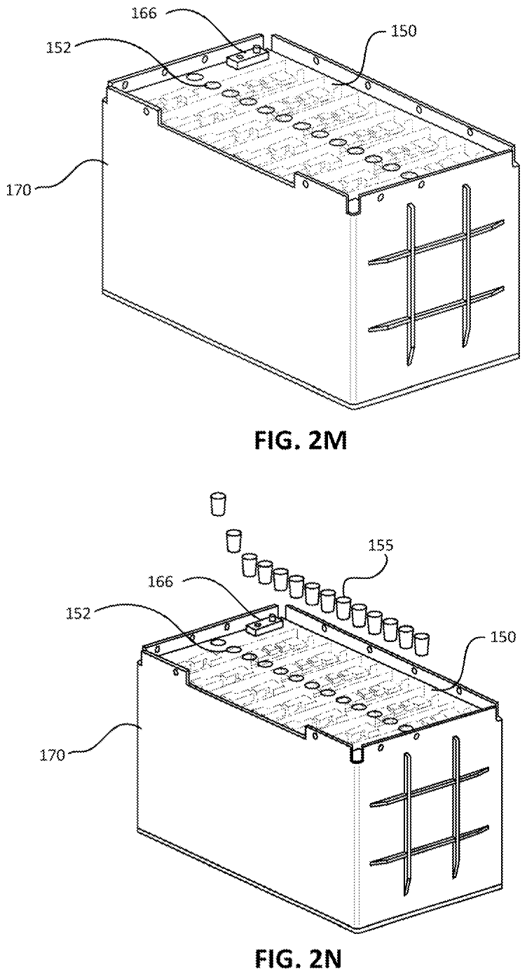

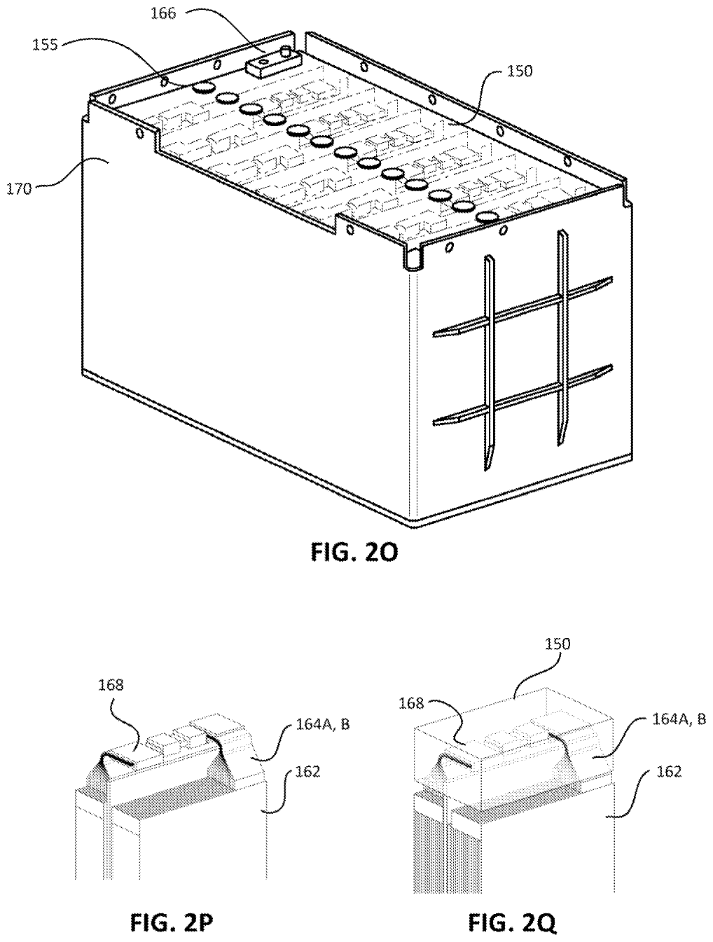

FIG. 2A illustrates a perspective view of a plurality of sets of electrodes 162 of a battery pack inserted within compartments 172 of an enclosure 170, in accordance with various embodiments of the subject technology. The plurality of sets of electrodes 162 each comprise a set of layers that include at least one cathode layer with an active coating, at least one anode layer with an active coating, and a separator disposed between the cathode layer and the anode layer. The set of layers may be stacked or wound. A first cathode tab 164A may extend from the cathode layer of a first set of electrodes 162A and a first anode tab 164B may extend from the anode layer of the first set of electrodes 162A. The set of electrodes comprise electrodes, current collectors, tabs, and separators, and may contain alignment features, but do not contain electrolyte, and are unsealed or otherwise enclosed within a pouch or can when disposed within each compartment 172.

Depending on the location of the first set of electrodes 162A with respect to other sets of electrodes 162 of the battery pack, the cathode tab 164A of the first set of electrodes 162A may be connected to an anode tab of an adjacent set of electrodes 162. Alternatively, the cathode tab 164A of the first set of electrodes 162A may be connected to a first terminal 166. The anode tab 164B of the first set of electrodes 162A may be connected to a cathode tab of an adjacent set of electrodes 162. Alternatively, the anode tab 164B of the first set of electrodes 162A may be connected to a second terminal 166. The first and second terminals 166 extend from the enclosure 170 and provide an external electrical connection to the plurality of sets of electrodes 162.

The enclosure 170 is formed of a rigid material, such as a polymer, composite, coated alloy, or other material as would be known by a person of ordinary skill. The enclosure 170 includes a plurality of compartments 172 that are defined by partitions 174. Each compartment is configured to receive a corresponding set of electrodes 162.

FIG. 2B illustrates a detailed view of a terminal 166 of a battery pack, in accordance with various embodiments of the subject technology. The cathode or anode tabs, 164A and 164B respectively, of a set of electrodes 162 may be coupled to the terminal 166 through use of a fastener 167. Alternatively, the cathode or anode tabs, 164A and 164B respectively, may be coupled to the terminal 166 through use of a welding operation. Other coupling operations may be used to couple the tabs 164A, B to the terminal 166, as would be understood by a person of ordinary skill in the art.

FIG. 2C illustrates a partially assembled battery, in accordance with various embodiments of the subject technology. The plurality of sets of electrodes of the battery pack 160 may be connected in series, with the cathode and anode tabs facilitating such connections through use of a connector 168.

FIG. 2D illustrates a perspective view of a mold 200 disposed atop of a partially assembled battery, in accordance with various embodiments of the subject technology. The mold 200 is disposed over an opening of the enclosure 170 containing a battery pack 160 comprising a plurality of sets of electrodes that are individually arranged within corresponding compartments. As discussed further below, the mold 200 is utilized to form a singular encapsulant layer to seal the plurality of sets of electrodes within their respective compartments and to further fully encapsulate connections 168 between the sets of electrodes.

Specifically, the encapsulant layer seals each compartment 172 from other compartments 172 and when the plurality of ports 152 (as shown in FIG. 2M) are plugged by a plurality of plugs 155 (as shown in FIG. 2N), the encapsulant layer seals the plurality of compartments from the environment. In one aspect, the encapsulant layer may seal each set of electrodes within their respective compartments. The seal created by the encapsulant layer may be hermetic or liquid-tight depending on the battery chemistry utilized in the battery. In other aspects, the encapsulating layer encapsulates the electrical connections between the sets of electrodes to prevent any corrosion to the electrical connections that may be caused by an electrolyte disposed within each compartment where a material difference between a cathode and anode tab may result in a parasitic reaction. In such an instance, the encapsulating layer also seals the electrical connections between the sets of electrodes against water or electrolyte for aqueous battery chemistries.

FIG. 2E illustrates an exploded view of a mold 200, in accordance with various embodiments of the subject technology. The mold 200 includes a base 201 defining a fill cavity and having a fill port 210 in fluid communication with the fill cavity that is configured to receive a liquid encapsulant. In one aspect, the base 201 may include a second fill port 210 in fluid communication with the fill cavity. The base 201 further includes a plurality of protrusions 220 extending through the fill cavity that are configured to form a plurality of ports within a cured encapsulant layer formed within the fill cavity. The plurality of ports are configured to receive electrolyte, as discussed below with reference to FIGS. 2M and 2N. The base 201 may further include a plurality of sense line pass-throughs 226 to receive a wire or sense line that is configured to sense each set of electrodes, a vent 228 for allowing air to discharge from the mold 200 as the liquid encapsulant is poured into the port 210, and a terminal pass-through 229 to receive a terminal from the battery pack disposed within the enclosure 170. Where a battery management unit is utilized to manage discharging, recharging, and cell balancing of the battery pack, sense lines may extend through the plurality of sense line pass-throughs 226 to detect a voltage of a particular set of electrodes.

To prevent liquid encapsulant from spilling out of the sense line pass-throughs 226 or the terminal pass-through 229, an O-ring 222 is used for the sense line pass-throughs 226 and a gasket 224 is used for the terminal pass-through 229, in conjunction with a press bar 230 to compress the O-ring 222 and the gasket 224 to thereby create a seal and prevent the liquid encapsulant from spilling out therefrom. It is understood that use of sense lines and sense line pass-throughs 229 are optional.

FIG. 2F illustrates a detailed view of a terminal pass-through 229 of a mold 200, in accordance with various embodiments of the subject technology. The terminal 166 is disposed within the terminal pass-through 229. The gasket 224 is disposed within the terminal pass-through 229 and at a periphery of the terminal 166. As discussed above, upon compression of the gasket 224 by a press bar, the gasket expands against the terminal 166 and sidewalls of the terminal pass-through 229 to create a seal to prevent a liquid encapsulant from spilling or leaking out. In one aspect, there may be a first press bar 230 configured to be used to compress a gasket 224 utilized in a first terminal pass-through for a first terminal 166, and a second press bar 230 configured to be used to compress a second gasket 224 utilized in a second terminal pass-through for a second terminal 166. The second press bar 230 is configured to compress the second gasket 224 to cause the second gasket 224 to expand and create a seal between the second terminal pass-through 229 and the second terminal 166.

FIG. 2G illustrates a perspective view of a mold 200 and battery assembly, in accordance with various embodiments of the subject technology. The mold 200 is configured to fit over an open end of the enclosure 170 to thereby create a cavity between the plurality of compartments of the enclosure 170 and the mold 200.

FIG. 2H illustrates a perspective view of a rotated mold 200 and battery assembly, in accordance with various embodiments of the subject technology. To facilitate formation of the singular encapsulant layer, as discussed further below, the mold 200 and enclosure 170 are rotated such that the fill port 210 of the mold 200 is positioned to receive a liquid encapsulant.

FIG. 2I illustrates a perspective section view of a mold 200 and battery assembly, in accordance with various embodiments of the subject technology. To facilitate alignment of the mold 200 with respect to the enclosure 170, the enclosure may include an alignment tab 176 and the mold 200 may include a corresponding slot 240 surrounding the fill cavity of the mold 200. The slot 240 is configured to receive the alignment tab 176 of the enclosure 170 to thereby align the enclosure 170 with respect to the mold 200.

FIG. 2J illustrates a section view of a mold 200 and battery assembly with a liquid encapsulant 300, in accordance with various embodiments of the subject technology. To form the singular encapsulant layer 150 (as shown in FIG. 1), liquid encapsulant 300 is poured within the fill port 210 to fill the fill cavity 310 with liquid encapsulant 300. The liquid encapsulant 300 flows into the cavity 310 and flows within a portion of each compartment 172 (as shown in FIG. 2A) to thereby seal each compartment 172. In one aspect, to enable the liquid encapsulant 300 to adequately bond with sidewalls of the enclosure 170 and partitions 174 (as shown in FIG. 2A), sidewalls of the enclosure 170 and the partitions 174 may include roughened surface or undulating features to increase a surface area that is to be in contact with the liquid encapsulant 300. The fill cavity 310 is defined by an internal void formed by the mold 200 and the enclosure 170 and includes portions of the compartments 172. Specifically, the fill cavity 310 is disposed proximate to ends of the plurality of sets of electrodes that are individually disposed within compartments 172 of the enclosure 170. As shown, the alignment tab 176 of the enclosure 170 is slid within a corresponding slot 240 of the mold 200.

In one example, the liquid encapsulant 300 may be a non-conductive epoxy. In another example, the liquid encapsulant 300 may be a polymer, wax, or other material that is resistant to corrosion that would be caused by an electrolyte. The liquid encapsulant 300 may be transformed into a solid state through use of a two-part cross-linking mixture, a one-part heat or moisture cure, or through use of a material with a low melting point that could be heated to a liquid and then cooled in the mold.

Specifically, and as further discussed below, once cured, the encapsulant layer 150 (as shown in FIG. 1) separates electrolyte disposed within each compartment 172 (as shown in FIG. 2A) from electrolyte disposed within other compartments 172 to prevent corrosion of the set of electrodes 162 (as shown in FIG. 2A). In addition, the encapsulant layer 150 (as shown in FIG. 2A) encapsulates electrical connections between the plurality of sets of electrodes 162 (as shown in FIG. 2A) and seals the plurality of sets of electrodes 162 (as shown in FIG. 2A) within their respective compartments 172 (as shown in FIG. 2A).

In one aspect, the singular encapsulant layer 150 extends along a width and depth of the enclosure 170, conforms to sidewalls of the enclosure 170, and also conforms to portions of sidewalls and partitions 174 of each compartment 172 to thereby seal each set of electrodes 162 within its corresponding compartment 172.

FIG. 2K illustrates a perspective section view of a mold 200 and battery assembly with a singular encapsulant layer 150, in accordance with various embodiments of the subject technology. The plurality of protrusions 220 extend through the fill cavity and the encapsulant layer 150 to thereby create a plurality of ports within the cured encapsulant layer 150. The encapsulant layer 150 is disposed over the battery pack 160.

In one aspect, the mold 200 aligns the encapsulant layer 150 to be spaced away from ends of the plurality of sets of electrodes by a distance 151 to enable electrolyte to flow between the set of layers of each set of electrodes. A gap between the encapsulant layer 150 and the plurality of sets of electrodes may have a distance 151 of about 5 mm or less. In one aspect, by utilizing the set of electrodes (e.g., bare cells without packaging) instead of packaged battery cells (e.g., fully assembled and packaged cells filled with electrolyte), the distance 151 is reduced, thereby increasing packaging and volumetric efficiency when compared to what would otherwise be required to accommodate packaged battery cells. Specifically, packaged battery cells would otherwise increase the volume such that the distance 151 could be greater than 15 mm or 20 mm. In addition, use of packaged battery cells would further occupy additional volume along the width and depth of any enclosure.

FIG. 2L illustrates a perspective section view of a mold 200 and battery assembly with a singular encapsulant layer 150, in accordance with various embodiments of the subject technology. The mold 200 utilizes the press bar 230 to compress the O-ring 222 and the gasket 224 (as shown in FIG. 2E) to thereby create a seal and prevent the liquid encapsulant from spilling or leaking out of the mold 200.

FIG. 2M illustrates a perspective view of a battery assembly with a singular encapsulant layer 150, in accordance with various embodiments of the subject technology. After the liquid encapsulant cures, the mold 200 (as shown in FIGS. 2D-L) is removed from the enclosure 170. The encapsulant layer 150 is disposed over the plurality of compartments to thereby seal each set of electrodes of the plurality of sets of electrodes within their respective compartments. The encapsulant layer 150 allows the first and second terminals 166 to extend there-through. The encapsulant layer 150 further includes a plurality of ports 152 that were formed by the plurality of protrusions 220 (as shown in FIGS. 2E, 2K and 2L). In one aspect, there is a port 152 provided for each compartment such that the ports 152 are in fluid communication with their respective compartments of the enclosure 170.

FIG. 2N illustrates a perspective view of a battery assembly with a singular encapsulant layer 150, in accordance with various embodiments of the subject technology. Electrolyte is poured into each compartment of the plurality of compartments via the corresponding port 152. Electrolyte is disposed within each compartment of the plurality of compartments. After filling each compartment with electrolyte, the ports are plugged with plugs 155 that are configured to seal the electrolyte within the enclosure 170.

FIG. 2O illustrates a perspective view of a battery assembly with a singular encapsulant layer 150, in accordance with various embodiments of the subject technology. The ports are plugged by a plurality of plugs 155 to thereby keep electrolyte within each respective compartment. In one example, the plurality of plugs 155 may be affixed to each port through use of a tolerance or press-fit. In another example, the plurality of plugs 155 may be affixed to each port through use of an adhesive. In yet another example, the ports may be formed using an insert that includes a self-sealing feature (e.g., one way valve). The encapsulant layer 150 thus seals the electrolyte and set of electrodes within their respective compartments.

In one aspect, the encapsulant layer 150 may further encapsulate a management circuit module that is configured to manage discharging, recharging, and cell balancing of the battery pack. The management circuit module would be coupled to the first and second terminal 166 and/or each set of electrodes via sense lines such that the management circuit module may monitor and manage discharging, recharging, and cell balancing of the battery pack. The battery management circuit module may comprise an integrated circuit having cutoff field-effect transmitters (FETs), fuel-gauge monitor, cell-voltage monitor, cell-voltage balance, real-time clock, and/or a temperature monitor.

FIG. 2P illustrates a detailed view of a connection 168 between adjacent set of electrodes 162, in accordance with various embodiments of the subject technology. As discussed above, the cathode and anode tabs 164A, B of adjacent sets of electrodes 162 may be coupled together in series using the connector 168.

FIG. 2Q illustrates a detailed view of an encapsulated connection 168 between adjacent sets of electrodes 162, in accordance with various embodiments of the subject technology. The encapsulant layer 150 fully encapsulates the electrical connection 168 between the cathode and anode tabs 164A, B of adjacent sets of electrodes 162. As such, the encapsulant layer 150 not only seals the electrolyte and set of electrodes 162 within their respective compartments, but also fully encapsulates the electrical connections between sets of electrodes 162 to thereby prevent corrosion that may be caused by corrosive electrolyte, depending on the battery chemistry used for the battery.

In one aspect, by utilizing the encapsulant layer 150 to encapsulate the electrical connections between sets of electrodes 162, there is no need to individually and separately package the set of electrodes as the compartments in conjunction with the encapsulant layer 150 serve to fully enclose each set of electrodes 162 within its respective compartment, thereby increasing packaging efficiency and reducing a volume that would be otherwise occupied by the battery pack. Specifically, through use of the subject technology, by not requiring use of pre-assembled battery cells (e.g., packaged electrodes with electrolyte), volumetric efficiency of the battery 100 is improved in all directions as the subject technology eliminates the need to physically accommodate each individual enclosure or pouch of a battery cell, and further eliminates the need to accommodate “headspace” of such battery cells, as the electrical connections between the set of electrodes are entirely accommodated within the encapsulant layer.

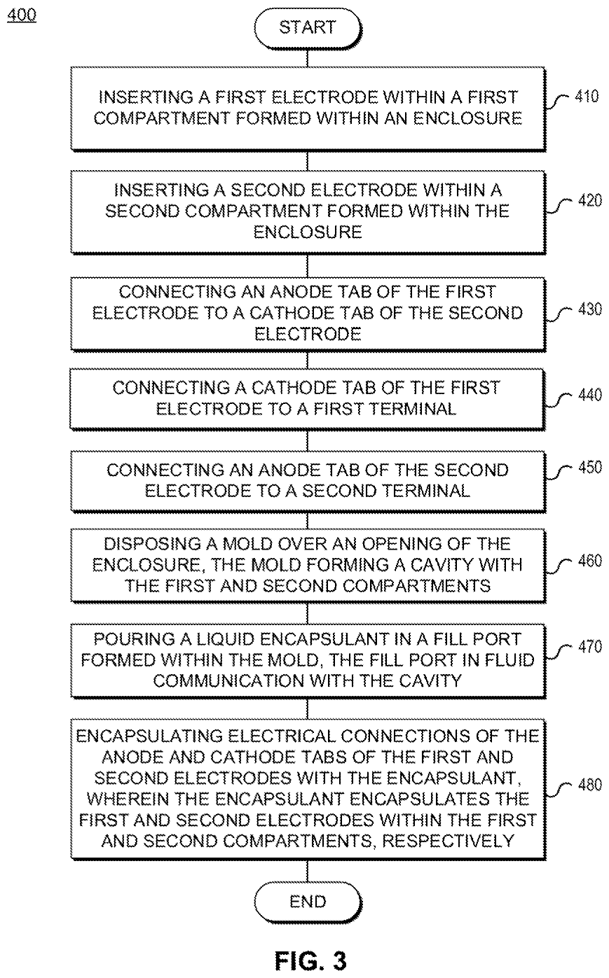

FIG. 3 illustrates an example method 400 for forming a singular encapsulant layer to seal a plurality of sets of electrodes within individual compartments of an enclosure, in accordance with various embodiments of the subject technology. It should be understood that, for any process discussed herein, there can be additional, fewer, or alternative steps performed in similar or alternative orders, or in parallel, within the scope of the various embodiments unless otherwise stated.

At operation 410, a first set of electrodes is inserted within a first compartment formed within an enclosure. At operation 420, a second set of electrodes is inserted within a second compartment formed within the enclosure. The first and second sets of electrodes each include a cathode layer, an anode layer, and a separator layer disposed between the cathode layer and the anode layer. The cathode layer includes a cathode tab extending therefrom, and the anode layer includes an anode tab extending therefrom. At operation 430, an anode tab of the first set of electrodes is connected to a cathode tab of the second set of electrodes. At operation 440, a cathode tab of the first set of electrodes is connected to a first terminal. At operation 450, an anode tab of the second set of electrodes is connected to a second terminal.

At operation 460, a mold is disposed over an opening of the enclosure to thereby form a singular cavity with the first and second compartments. At operation 470, a liquid encapsulant is poured in a fill port formed within the mold. The fill port is in fluid communication with the cavity. At operation 480, electrical connections of the anode and cathode tabs of the first and second sets of electrodes are encapsulated with the encapsulant to form a singular encapsulant layer. The singular encapsulant layer seals both of the first and second sets of electrodes within the first and second compartments, respectively. In one aspect, the encapsulant layer may be spaced away from ends of the plurality of sets of electrodes by a distance to enable electrolyte to flow between the set of layers of each set of electrodes. A gap between the encapsulant layer and the plurality of sets of electrodes may have a distance of about 5 mm or less.

The method 400 may also include aligning the enclosure with the mold by sliding a tab of the enclosure within a slot of the mold. The method 400 may also include placing a first gasket around the first terminal, and placing a first press bar against the first gasket to compress the first gasket against the first terminal to create a seal between the first terminal and the mold. The method 400 may further include placing a second gasket around the second terminal; and placing a second press bar against the second gasket to compress the second gasket against the second terminal to create a seal between the second terminal and the mold.

The method 400 may also include filling the first compartment with an electrolyte via a first port formed within the encapsulant layer, and filling the second compartment with the electrolyte via a second port formed within the encapsulant layer. The method 400 may further include plugging the first and second ports, and encapsulating a battery management unit within the encapsulant layer.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A battery, comprising:
a plurality of sets of electrodes, each set of electrodes includes a cathode layer, an anode layer, and a separator layer disposed between the cathode layer and the anode layer, wherein the cathode layer includes a cathode tab extending therefrom, and wherein the anode layer includes an anode tab extending therefrom;
an enclosure having a plurality of compartments, wherein each compartment is configured to receive a corresponding set of electrodes; and
a singular encapsulant layer disposed over the plurality of compartments, the encapsulant layer sealing each set of electrodes of the plurality of sets of electrodes within their respective compartment of the plurality of compartments, wherein the encapsulant layer fully encapsulates an electrical connection of the anode tab and the cathode tab for each set of electrodes of the plurality of sets of electrodes.

2. The battery of claim 1, further comprising a first and second terminal extending from the enclosure, the first and second terminal electrically coupled to the plurality of sets of electrodes, wherein the encapsulant layer allows the first and second terminal to extend there-through.

3. The battery of claim 2, further comprising a management circuit module coupled to the first and second terminal, the management circuit module fully encapsulated within the encapsulant layer.

4. The battery of claim 1, further comprising an electrolyte disposed within each compartment of the plurality of compartments, wherein the encapsulant layer further comprises a plurality of ports, the plurality of ports configured to allow the electrolyte to flow therethrough to fill each compartment of the plurality of compartments with the electrolyte.

5. The battery of claim 4, further comprising a plurality of plugs, each plug of the plurality of plugs configured to seal the electrolyte within the enclosure by engaging a corresponding port of the plurality of ports.

6. The battery of claim 1, wherein a gap between the encapsulant layer and the plurality of sets of electrodes is less than 5 mm.

7. The battery of claim 1, wherein the enclosure includes an alignment tab that is configured to align the enclosure to a mold configured to form the encapsulant layer.

8. The battery of claim 1, wherein the encapsulant layer comprises at least one of an epoxy, wax, and polymer.

9. A mold for forming a singular encapsulant layer to seal a plurality of sets of electrodes within individual compartments of an enclosure, the mold comprising:
a base defining a fill cavity,
a slot surrounding the fill cavity, the slot configured to receive a tab extending from a battery enclosure to align the battery enclosure with respect to the base;
a fill port in fluid communication with the fill cavity, the fill port configured to receive a liquid encapsulant;
a plurality of protrusions extending through the fill cavity, the plurality of protrusions configured to create a plurality of ports within a cured singular encapsulant layer formed within the fill cavity.

10. The mold of claim 9, further comprising:
a terminal pass-through configured to receive a terminal extending from the battery enclosure;
a gasket disposed within the terminal pass-through; and
a press bar disposed within the terminal pass-through and in contact with the gasket, the press bar configured to compress the gasket to cause the gasket to expand and create a seal between the terminal pass-through and the terminal.

11. The mold of claim 9, further comprising a second press bar, the second press bar configured to compress a second gasket to cause the second gasket to expand and create a seal between a second terminal pass-through and a second terminal.

12. A method for forming a singular encapsulant layer to seal a plurality of sets of electrodes within individual compartments of an enclosure, the method comprising:
inserting a first set of electrodes within a first compartment formed within an enclosure;
inserting a second set of electrodes within a second compartment formed within the enclosure, wherein the first and second sets of electrodes each include a cathode layer, an anode layer, and a separator layer disposed between the cathode layer and the anode layer, wherein the cathode layer includes a cathode tab extending therefrom, and wherein the anode layer includes an anode tab extending therefrom;
connecting an anode tab of the first set of electrodes to a cathode tab of the second set of electrodes;
connecting a cathode tab of the first set of electrodes to a first terminal;
connecting an anode tab of the second set of electrodes to a second terminal;
disposing a mold over an opening of the enclosure, the mold forming a singular cavity with the first and second compartments;
pouring a liquid encapsulant in a fill port formed within the mold, the fill port in fluid communication with the cavity; and
encapsulating electrical connections of the anode and cathode tabs of the first and second sets of electrodes with the encapsulant to form a singular encapsulant layer, wherein the encapsulant layer seals both of the first and second sets of electrodes within the first and second compartments, respectively.

13. The method of claim 12, further comprising aligning the enclosure with the mold by sliding a tab of the enclosure within a slot of the mold.

14. The method of claim 12, further comprising:
placing a first gasket around the first terminal; and
placing a first press bar against the first gasket to compress the first gasket against the first terminal to create a seal between the first terminal and the mold.

15. The method of claim 14, further comprising:
placing a second gasket around the second terminal; and
placing a second press bar against the second gasket to compress the second gasket against the second terminal to create a seal between the second terminal and the mold.

16. The method of claim 12, further comprising filling the first compartment with an electrolyte via a first port formed within the encapsulant layer.

17. The method of claim 16, further comprising filling the second compartment with the electrolyte via a second port formed within the encapsulant layer.

18. The method of claim 17, further comprising plugging the first and second ports.

19. The method of claim 12, further comprising encapsulating a battery management unit within the encapsulant layer.

20. The method of claim 12, wherein a gap between the encapsulant layer and the first and second sets of electrodes is less than 5 mm.
